(19) United States
(12) Patent Application Publication
(10) Pub. No.: US 2002/0133413 A1
(43) Pub. Date: Sep. 19, 2002

(54) System and method for purchasing an item displayed on a display device

(76) Inventors: Matthew S. Chang, San Diego, CA (US); Aditya Krishnan, San Diego, CA (US); Andrew M. Proehl, San Francisco, CA (US); David K.L. Yang, San Jose, CA (US); Frederick J. Zustak, Poway, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: WILLIAM S. FROMMER, Esq., c/o FROMMER LAWRENCE & HAUG LLP, 745 Fifth Avenue, New York, NY, 10151, US

(21) Appl. No.: 09/801,291

(22) Filed: Mar. 7, 2001

(51) Int. Cl. G06F 17/60

(52) U.S. Cl. 705/26

(57) ABSTRACT

A method and system for enabling a user to purchase an item displayed on a display screen of a television receiver which may be located in the user's home or office. The system may include a set-top box having a processor and a back-channel and adapted to receive television signals representative of a number of items offered for sale and provide the received television signals to the television receiver so as to enable the item or items offered for sale to be displayed on the display screen, and a credit card reader adapted to read information from a credit card when the credit card is provided thereto by the user and forward the read information to the set-top box. The set-top box may process the information received from the credit card reader and supply the same to an external destination such as a store, a credit card company, a manufacturer or the like so as to enable payment for a desired item without necessarily storing such information in the STB. By ensuring that the user uses a physical credit card, and not just a credit card number and potentially with additional authentication such as confirmation of telephone number of line used (using CALLER ID, for instance), the present invention may reduce the likelihood of fraud.

### BACKGROUND OF THE INVENTION

The present invention relates generally to a purchasing system and method and, more particularly, to such system and method for enabling a user to purchase an item displayed on a display screen of a television receiver.

Today, a customer may purchase an item or items which are displayed on a television screen from his or her home or office. For example, a shopping company may cause a number of items for sale to be advertised over a television channel. While viewing such channel on the television screen, if a customer sees an item or items he or she wishes to purchase, the customer may contact the shopping company by telephone and purchase the desired item or items. During such telephone conversation, the customer may arrange to pay for such item(s) by providing the representative of shopping company with a number from one of the customer's credit cards.

As is to be appreciated, by merely providing a number from a credit card in the above-described transaction, the possibility of fraud may exist. For example, the person purchasing the item(s) may not be the owner or authorized user of the credit card and may not have the actual credit card. Instead, such person may have fraudulently or illegally obtained the credit card number and may have used such credit card number to purchase the item(s).

### OBJECTS AND SUMMARY OF THE INVENTION

It is an object of the present invention to provide a system and method in which a user may purchase an item displayed on a television screen which reduces the likelihood of fraud.

More specifically, it is an object of the present invention to provide a system and method as aforesaid in which the user purchases and/or arranges for the payment of a desired item(s) displayed on a television screen by using a card reader to read information from a respective credit card, debit card, or the like.

An aspect of the present invention is to provide a system for enabling a user to purchase an item displayed on a display screen of a television receiver comprising a commerce device coupled to the television receiver adapted to receive television signals representative of a number of items offered for sale and provide the received television signals to the television receiver so as to enable the item or items offered for sale to be displayed on the display screen, and a card reader adapted to read information from a card and forward the read information to the commerce device. The present invention also provides the corresponding method.

The above and other objects, features and advantages according to the present invention will be apparent from the following detailed description of the illustrated embodiments when read in conjunction with the accompanying drawings in which corresponding components are identified by the same reference numerals.

### BRIEF DESCRIPTION OF THE DRAWINGS

FIG. 1 is a system block diagram of a system using a set-top box;

FIG. 2 is a functional block diagram of a digital set-top box suitable for use with the present invention; and

FIG. 3 is a diagram of a system according to an embodiment of the present invention.

### DETAILED DESCRIPTION OF PREFERRED EMBODIMENTS

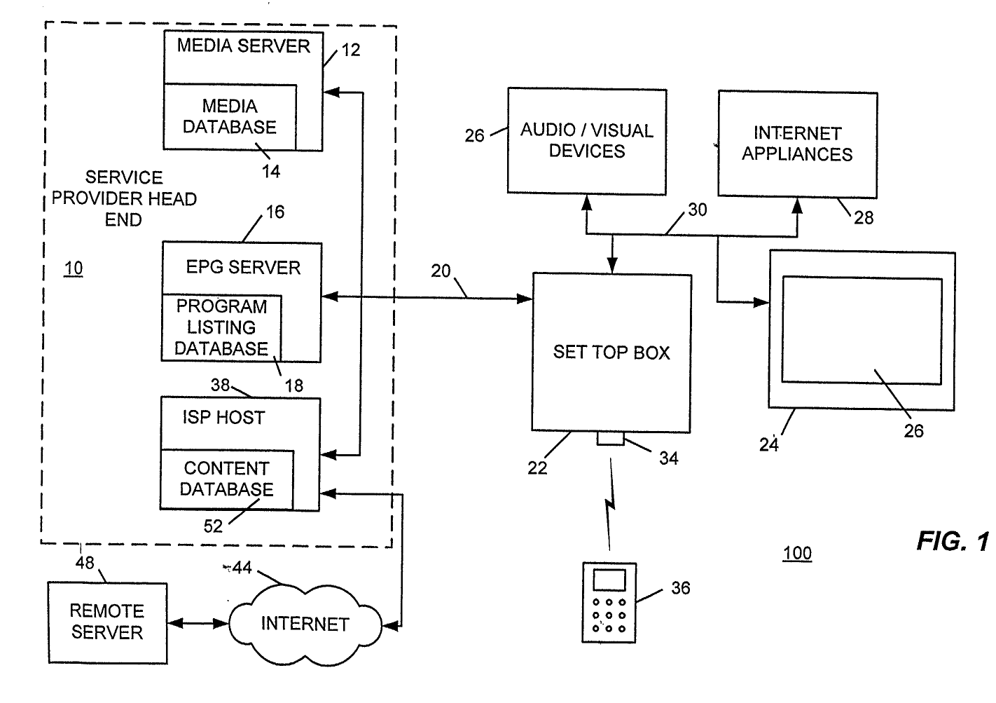

The preferred embodiments of the present invention will be described with reference to the accompanying drawings. Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bi-directional communication over a transmission medium 20 in the case of a cable STB 22. In other embodiments, bi-directional communication can be effected using asymmetrical communication techniques possibly using dual communication media—one for the uplink and one for the downlink. In any event, the STB 22 can have its own Universal Resource Locator (URL) assigned thereto to provide for addressability by the head end and users of the Internet.

The media server 12 and EPG server 16 are coupled by transmission medium 20 to set top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB.

The exemplary system 100 further includes a TV 24, such as a digital television, having a display 26 for displaying programming, an EPG, etc. The STB 22 may be coupled to the TV 24 and various other audio/visual devices 26 and Internet Appliances 28 by an appropriate interface 30, which can be any suitable analog or digital interface. In one embodiment, interface 30 conforms to an interface standard such as the Institute of Electrical and Electronics Engineers (IEEE) 1394 standard. The STB 22 may include a central processing unit (CPU) and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g. using a cable modem) to, thus, provide access to services and content from the ISP and the Internet. The ISP host 38 provides various content to the user that is obtained from a content database 52. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

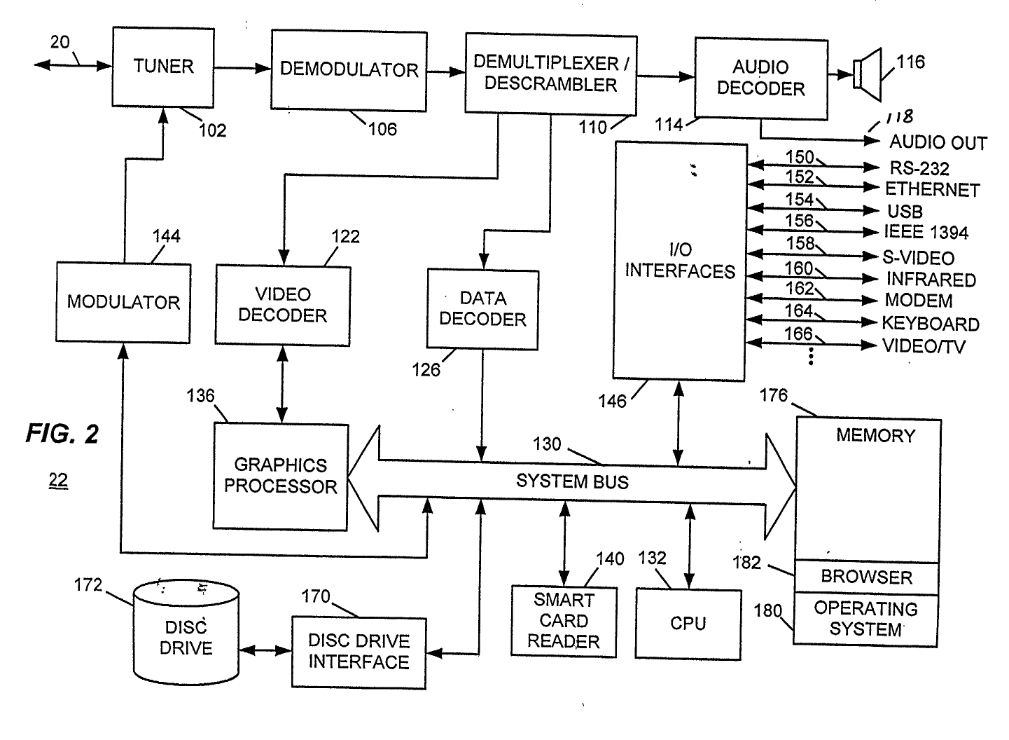

Referring now to FIG. 2, a typical system configuration for a digital set-top box 22 is illustrated. In this exemplary set-top box, the transmission medium 20, such as a coaxial cable, is coupled by a suitable interface to a tuner 102. Tuner 102 may, for example, include a broadcast in-band tuner for receiving content, an out-of-band tuner for receiving data transmissions and a return path tuner for providing an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g. audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g. stereo or home theater multiple channel audio systems) or other audio system 116 (e.g. stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to process graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

STB 22 may incorporate a smart card reader 140 for communicating with a so called “smart card”, often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bi-directional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the tuner (operating as a return path OOB tuner) and out through the transmission medium 20. This capability is used to provide a mechanism for the STB 22 and/or its user to send information to the head end (e.g. service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire or i-link) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bi-directional communication via the DOCSIS cable modem with the STB 22 being identified by an unique URL (Universal Resource Locator).

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 may include a disc drive interface 170 and disc drive mass storage 172 for user storage of content and data as well as providing storage of programs operating on CPU 132. STB 22 may also, include floppy disc drives, CD ROM drives, CD R/W drives, DVD drives, etc. CPU 132, in order to operate as a computer, is coupled through the system bus 130 to memory 176. Memory 178 may include a combination of any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention.

In general during operation of the STB 22, an appropriate operating system 180 such as Sony Corporation's Aperios™ real time operating system is loaded into, or is permanently stored in, active memory along with the appropriate drivers for communication with the various interfaces. Along with the operating system and associated drivers, the STB 22 usually operates using browser software 182 in active memory or may permanently reside in ROM or EEPROM. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all may include at the lowest layer various hardware interface layers. Next is an operating system layer as previously described. The software architectures of the STB may include a next layer referred to as “middleware”. Such middleware permits applications to run on multiple platforms with little regard for the actual operating system in place. Middleware standards may be based upon JavaScript and HTML (HyperText Markup Language) virtual machines. At the top layer is the application layer where user applications and the like reside (e.g. browsing, email, EPG, Video On Demand (VOD), rich multimedia applications, pay per view, etc.). The current invention can be utilized with any suitable set-top box software architecture.

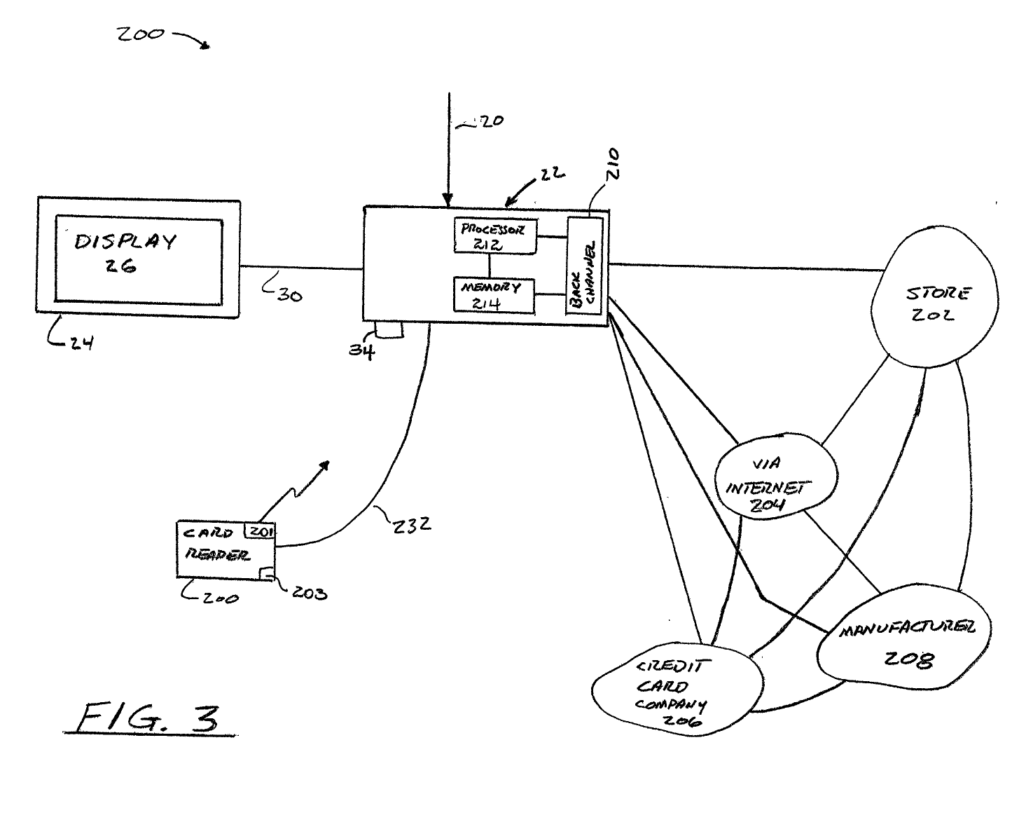

FIG. 3 illustrates a purchasing system 200. As shown therein, such system may include television 24 with display 26, a commerce device such as STB 22, and a card reader 200.

The card reader 200 may be adapted to read information from a credit card or the like and to supply such information to the STB 22 by way of cable 232. The credit card may be a magnetic-stripe type credit card which has a magnetic stripe having information stored therein and the card reader 200 may be configured as a magnetic stripe card reader so as to read information from the magnetic stripe area of the credit card. Alternatively, the card reader 200 may include a transmitting device 201 for transmitting the read information in a wireless manner (such as by use of infrared signals) for reception by a receiving device of the STB 22 (such as infrared receiver 34). As another alternative, the card reader 200 may be integrated into a remote control device (such as remote control 36) usable with the STB 22 or the television 24 and may read information from the credit card and supply the same to the STB 22 in a wireless manner (such as by use of infrared signals).

The STB 22 may be coupled to transmission medium 20 which, in turn, may be coupled to service provider 10 so as to receive television programming therefrom, in a manner as previously described. The STB 22 may also be coupled to the television 24 by way of a cable or interface such as interface 30 and/or output 166 so as to provide received television programming thereto for display on display 26.

Additionally, the STB 22 may be adapted to receive information from the card reader 200, such as by way of cable 232. The information received from the card reader 200 may be processed by processor 212, which may include a number of components such as demultiplexer/descrambler 110 and CPU 132 (FIG. 2). Such processing may include formatting and packetizing of the information data in a predetermined manner. The processed information may be supplied to a respective destination by way of a back channel 210. The back channel 210 may be configured in a manner similar to that previously described with regard to the I/O interfaces 146. For example, the back channel 210 may be a modem coupled to a telephone line (such as a plain old telephone service (POTS) line), a cable modem coupled to a cable modem, a DSL modem coupled to a DSL connection, an integrated services digital network (ISDN) line, an Ethernet connection to a network, a wireless connection to a network, and so forth. The destination may be an on-line or retail store 202, a cable or credit card company 206, a manufacturer 208, and so forth. Further, the processed information may be directly supplied to the respective destination or, alternatively, may be supplied thereto by way of the Internet 204. Additionally, the STB 22 may be adapted to receive information, such as acknowledgement signals as hereinafter described, from the store 202, credit card company 206, manufacturer 208 or the like by way of the back channel 210 either directly or indirectly by way of the Internet. Communication between the STB 22 and an external destination (such as the store 202, credit card company 206 or manufacturer 208) may be performed in a manner similar to that previously described.

The STB 22 may also include a memory 214 (which may include memory 176) wherein information obtained from the card reader 200 may be stored.

The television 24, STB 22, and card reader 200 may be separate units or, alternatively, two or more of them may be combined into a single unit. For example, the television 24, STB 22, and card reader 200 may be arranged in a single unit. As another example, the television 24 and STB 22 may be arranged in a single unit and the card reader 200 may be arranged in another separate unit.

In operation, television programming signals representing a number of items for sale by on-line or retail store 202, cable or credit card company 206, manufacturer 208, or the like may be supplied by way of the transmission medium 20 to the STB 22 whereupon the signals may be processed and supplied to the television 24 by way of the cable 30. As a result, pictures corresponding to the item(s) for sale may be displayed on the display 26. Upon viewing an item which the user wishes to purchase, the user may contact the store, card company, manufacturer or the like by telephone and indicate that he or she wishes to purchase the desired item. Alternatively, the user may activate a buy button 203, which may be arranged on the card reader 200 or the STB 22, whereupon a buy signal may be generated and supplied from the back channel 210 of the STB 22 to the appropriate store, company, or manufacturer. To pay for the desired item, the user swipes his or her credit card through the card reader 200, whereupon information from the user's credit card is supplied to the STB 22 by way of the cable 232 or in a wireless manner. Such information from the user's credit card may include the card holder's name, telephone number, billing address, and/or security or authentication information.

The received credit card information is processed in a predetermined manner by the processor 212 which may involve formatting and packetizing the information. The processed information is supplied to the appropriate one of the store 202, credit card company 206 or manufacturer 208 by way of the back channel 210 either directly or indirectly by way of the Internet. Upon receipt of such information, the store 202, credit card company 206 or manufacturer 208 may supply an acknowledgement signal to the STB 22, whereupon such signal may be processed and supplied to the display 26 so as to be display thereat, thereby informing the user that the credit card information was properly received by the store, company or manufacturer.

In the above-described arrangement, the processed credit card information is transferred or supplied to the store 202, credit card company 206, manufacturer 208, Internet, or the like without being stored in the STB 22. Since the credit card information is not stored within the STB 22 and, as such, may not be fraudulently obtained at a later time, such arrangement may be relatively secure. However, if desired such as to facilitate data transmission or the like, the STB 22 and/or the card reader 200 may include a memory such as the memory 214 which may be integrated in the STB or be removable such as Memory Stick, Smart Disk, etc. for storing the credit card information.

Further, information pertaining to a respective user or users may be initially provided to the STB 22 and stored in a memory therein (such as memory 214) or supplied to an external data base and stored thereat. Subsequently, during a purchase transaction, the information read from a credit card may be compared to the previously stored user information by use of the processor 212 and, if the newly read credit card information is not compatible with the previously stored user information, the STB 22 may terminate or otherwise not allow the purchase transaction to continue. As is to be appreciated, this arrangement further ensures against fraudulent use of credit cards in a purchase transaction.

Furthermore, as previously mentioned, the credit card information may include the user or card holder's telephone number. During a purchase transaction, the store 202, credit card company 206, manufacturer 208 or the like may compare the telephone number obtained from the credit card information with the telephone number the user is currently using to make the purchase using identification information such as given by CALLER ID and, if the telephone numbers do not match, terminate the transaction or advise the user of such discrepancy and await further confirmation that the current user is an authorized user thus giving a further level of security.

Therefore, the present invention provides an arrangement wherein a user from his or her home or office may more securely purchase a number of items which are displayed on a display unit such as a television display (t-commerce) and pay for such item(s) by use of a credit card reader. Alternatively, the present invention may also be applicable to e-commerce arrangements (such as a situation utilizing a STB, interactive television and a credit card reader and wherein items to be purchased are provided by way of the Internet). As is to be appreciated, by utilizing a credit card reader, the present invention ensures that the person paying for an item or items has a credit card and not just a number from such credit card. Accordingly, the present invention reduces the possibility of fraud which may otherwise occur when a person pays for an item or items with merely a credit card number that was fraudulently obtained. Further, a credit card reader such as that utilized in the present invention is relatively easy to operate and may be fabricated at a relatively low cost.

Further, although in describing the present invention the credit card was described as a magnetic-stripe type credit card and the card reader 200 was described as being a magnetic-stripe card reader, the present invention is not so limited. That is, other types of credit cards and credit card readers may be utilized in the present invention. For example, the card may be a smart card such as a so-called SIM IC type card, a contactless integrated circuit (IC) type card having a contactless-type integrated circuit (IC) chip with information stored therein, a debit card, an automated teller machine (ATM) card, and so forth; and, the card reader 200 may be configured as a smart card reader so as to read information from a smart card, a contactless type card reader so as to read information from a card having a contactless-type IC chip, and so forth. Additionally, the card reader 200 may be configured as one or more of a magnetic stripe card reader, a smart card reader, a contactless type card reader, and so forth so as to read information from a plurality of types of cards.

Furthermore, although in the above description, element 22 was described as a set top box, the present invention is not so limited. That is, in addition to a set-top box type commerce device, other types of commerce devices such as interactive cable boxes, interactive television receivers, satellite television decoder boxes, and the like may be used.

Additionally, the use of a credit card with the credit reader 200 may be utilized to restrict or limit available television programs. For example, consider the above-described situation wherein the credit card reader 200 is incorporated into the remote control 36 and wherein the system has a parental control arrangement. In such situation, a credit card used with the credit card reader 200 may enable an authorized viewer (such as a parent) to view a respective program.

Although preferred embodiments of the present invention and modifications thereof have been described in detail herein, it is to be understood that this invention is not limited to these embodiments and modifications, and that other modifications and variations may be effected by one skilled in the art without departing from the spirit and scope of the invention as defined by the appended claims.

What is claimed is:

1. A system for enabling a user to purchase an item displayed on a display screen of a television receiver, said system comprising:
means adapted to be coupled to said television receiver for receiving television signals representative of a number of items offered for sale and for providing the received television signals to said television receiver so as to enable the item or items offered for sale to be displayed on said display screen; and
reading means for reading information from a card and for forwarding the read information to the receiving and providing means.

2. A system as in claim 1, wherein the receiving and providing means includes means for processing the read information in a predetermined manner and for outputting the same for supply to an external destination so as to enable payment for a desired item.

3. A system as in claim 2, wherein said card includes a magnetic storage area having information stored therein and wherein said reading means reads the stored information from said magnetic storage area.

4. A system as in claim 2, wherein said card includes an integrated circuit (IC) chip having information stored therein and wherein said reading means reads the stored information from said IC chip.

5. A system as in claim 2, wherein the receiving and providing means includes a set-top box.

6. A system as in claim 2, wherein the reading means is coupled to the receiving and providing means by way of a data line and wherein the reading means forwards the read information to said receiving and providing means by way of said data line.

7. A system as in claim 2, wherein the reading means includes transmitting means for transmitting the read information in a wireless manner to the receiving and providing means.

8. A system for enabling a user to purchase an item displayed on a display screen of a television receiver, said system comprising:
a commerce device coupled to said television receiver adapted to receive television signals representative of a number of items offered for sale and provide the received television signals to said television receiver so as to enable the item or items offered for sale to be displayed on said display screen; and
a card reader adapted to read information from a card and forward the read information to the commerce device.

9. A system as in claim 8, wherein the commerce device includes a processor and a back-channel for processing the read information in a predetermined manner and for outputting the same for supply to an external destination so as to enable payment for a desired item.

10. A system as in claim 9, wherein said card includes a magnetic storage area having information stored therein and wherein said card reader reads the stored information from said magnetic storage area.

11. A system as in claim 9, wherein said card includes an integrated circuit (IC) chip having information stored therein and wherein said card reader reads the stored information from said IC chip.

12. A system as in claim 9, wherein the commerce device is a set-top box.

13. A system as in claim 9, wherein the card reader is coupled to the commerce device by way of a data line and wherein the card reader forwards the read information to said commerce device by way of said data line.

14. A system as in claim 9, wherein the card reader includes a transmitter which transmits the read information in a wireless manner to the commerce device.

15. A system for enabling a user to purchase an item displayed on a display screen of a television receiver, said system comprising:
a set-top box having a processor and a back-channel and adapted to receive television signals representative of a number of items offered for sale and provide the received television signals to said television receiver so as to enable the item or items offered for sale to be displayed on said display screen; and
a credit card reader adapted to read information from a credit card when said credit card is provided thereto by said user and forward the read information to the set-top box,
wherein said set-top box processes the information received from said credit card reader in a predetermined manner and outputs the same by way of the back-channel for supply to an external destination so as to enable payment for a desired item.

16. A system as in claim 15, wherein said credit card includes a magnetic storage area having information stored therein and wherein said credit card reader reads the stored information from said magnetic storage area.

17. A system as in claim 15, wherein said credit card includes an integrated circuit (IC) chip having information stored therein and wherein said credit card reader reads the stored information from said IC chip.

18. A system as in claim 15, wherein the external destination is one of a store, a credit card company, and a manufacturer.

19. A method for enabling a user to purchase an item displayed on a display screen of a television receiver, the method comprising the steps of:
receiving television signals at a receiving device representative of a number of items offered for sale and providing the received television signals to a television receiver so as to enable the item or items offered for sale to be displayed on said display screen; and
reading information from a card and forwarding the read information to the receiving device.

20. A method as in claim 19, further comprising the steps of processing the read information in a predetermined manner from the receiving device and outputting the same for supply to an external destination so as to enable payment for a desired item.

21. A method as in claim 20, wherein said card includes a magnetic storage area having information stored therein and wherein the stored information is read from said magnetic storage area during the reading step.

22. A method as in claim 20, wherein said card includes an integrated circuit (IC) chip having information stored therein and wherein the stored information is read from said IC chip during the reading step.

23. A method as in claim 20, wherein the receiving device includes a set-top box.

24. A method as in claim 20, wherein the read information is forwarded to said receiving device by way of a data line.

25. A method as in claim 20, wherein the read information is forwarded in a wireless manner to the receiving device.

26. A method for enabling a user to purchase an item displayed on a display screen of a television receiver, said method comprising the steps of:
coupling a set-top box having a processor and a back-channel so as to receive television signals representative of a number of items offered for sale and provide the received television signals to said television receiver so as to enable the item or items offered for sale to be displayed on said display screen; and
reading information from a credit card by use of a credit card reader when said credit card is provided thereto by said user and forwarding the read information to the set-top box,
wherein said set-top box processes the information received from said credit card reader in a predetermined manner and outputs the same by way of the back-channel for supply to an external destination so as to enable payment for a desired item.

27. A method as in claim 26, wherein said credit card includes a magnetic storage area having information stored therein and wherein said credit card reader reads the stored information from said magnetic storage area.

28. A method as in claim 26, wherein said credit card includes an integrated circuit (IC) chip having information stored therein and wherein said credit card reader reads the stored information from said IC chip.

29. A method as in claim 26, wherein the external destination is one of a store, a credit card company, and a manufacturer.
